(19) United States
(12) Patent Application Publication
(10) Pub. No.: US 2009/0028270 A1
(43) Pub. Date: Jan. 29, 2009

(54) MIMO BROADBAND CHANNEL EMULATOR

(75) Inventor: Hui-Chun Chen, Hsinchu (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Gemtek Technology Co., Ltd.

(21) Appl. No.: 11/829,307

(22) Filed: Jul. 27, 2007

(51) Int. Cl. H04L 27/20

(52) U.S. Cl. 375/308

(57) ABSTRACT

The present invention relates to a multiple input, multiple output broadband channel emulator. The broadband emulator having RF input signals comprises a mixing matrix. The mixing matrix includes two broadband splitters, two broadband combiners, one phase shifter. More particularly, the broadband power splitter/combiner includes four transmission lines, a resistor being provided as a termination, and a 180 degree phase shifter, wherein the phase shifter is positioned in the transmission path.

### BACKGROUND OF THE INVENTION

1. Field of the Invention

The present invention relates to a multiple input, multiple output broadband emulator. More particularly, the present invention relates to a broadband splitter/combiner.

2. Description of the Prior Art

As is well known, multiple input, multiple output (MIMO) communication systems use multiple transmitters and receivers to enhance the reliability and signal capacity of the communication link. Fixed channel Matrix is necessary for establishing robust test environment. However the bandwidth of the conventional channel emulator is narrow which can not support the testing on current multi-mode/multi-band products.

FIG. 1 shows a conventional two-channel emulator 10 illustrated in a simplified block schematic diagram. The RF input signals to the channel emulator 10 is provided to a first input channel 1 and to a second input channel 2.

The channel emulator 10 includes a mixing matrix 12 having two power splitters 20 and 21, two power combiners 22 and 23, a 180 degree phase shifter 24. Additionally, the power splitters can also perform vector summation of two or more signals and thus can be used as power combiners.

Each power splitter 20, 21 divides the input signals into two first signals 202, 212 and two second signals 204, 214. The phase shifter 24 provides additional 180 degree phase shift on the second signal 214. The power combiner 22 combines the non-phase shifted first signal 202 and the phase-shifted second signal 214 and generates an output signal to an output channel 3. The power combiner 23 combines both the non-phase shifted first signal 212 and second signal 204 and generates an output signal to an output channel 4.

FIG. 2, shows a conventional power splitter 20 illustrated in a simplified schematic diagram. The power splitter 20 includes four transmission lines 210, 220, 230, 240 and a 50 Ohm resistor 250 which acts as a termination. The transmission line 210 connects with the input channel 1 and an output port 260. Similarly, the transmission line 220 connects with the input channel 1 and an output port 270. The transmission line 230 connects with the output port 270 and the resistor 250. The transmission line 240 connects with the output port 260 and the resistor 250. Each transmission line 210, 220, 230 is a 90 degree transmission line and characterized by a characteristic impedance of 70.7 Ohm. The transmission line 240 is a 270 degree transmission line and characterized by a characteristic impedance of 70.7 Ohm. As described above, the power splitter 21, the power combiner 23, 24 can be known by the skilled person.

FIG. 3, shows a simulation result of a channel emulator available in the prior art comprises the narrowband power splitters. As a result, the conventional channel emulator comprises narrowband power splitter constrained to operate in narrow frequency bands. In short, the narrow band power splitter limits the bandwidth of the channel emulator. Normally, the fractional bandwidth could hardly more than 40%.

Because of the limitations of prior art systems, the bandwidth of the conventional emulator is narrow. It is desired to have an emulator that provides broadband power splitters operable over a broad frequency range more than an octave for example. In addition, it is desirable that the two output signals of the power splitter have constant output amplitude proportional to the input signal.

### SUMMARY OF THE INVENTION

Broadband Emulator

A broadband emulator having RF input signals comprises a mixing matrix which includes two broadband splitters, two broadband combiners, and one phase shifter.

Broadband Splitter

The broadband splitter receives one input signal and generates two output signal paths. The broadband splitter includes four transmission lines, a resistor is provided to act as a termination, and a phase shifter, wherein the phase shift is positioned in the transmission path.

The broadband splitters having two equal amplitude in-phase signals are isolated from each other and the phase shifter can improve bandwidth performance of the broadband emulator compared with the conventional channel emulator, apparently, it shows that the present invention is one of the candidates for RF emulation system.

The MIMO broadband emulator comprises a plurality of broadband splitters, each broadband splitter receiving one RE input signal and generating a plurality of signal paths. A plurality of broadband combiners are coupled to related the plurality of broadband splitters, each broadband combiner receiving more than one signal paths, at least one of the plurality of broadband combiners receives a phase-shifted signal path, and each the plurality of broadband combiner generating one output signal. At least one of phase shifters for phase shifting is coupled between the plurality of broadband combiners and the plurality of broadband splitters; and wherein each broadband splitter comprises transmission lines function as quarter-wave transformers providing a center frequency electrical transmission phase of 90 degree and one 180 degree phase shifter positioned in the one of the transmission line path for phase shifting.

### BRIEF DESCRIPTION OF THE DRAWINGS

The present invention will now be specified with reference to its preferred embodiment illustrated in the drawings, in which

FIG. 1 is a schematic view of a conventional channel emulator;

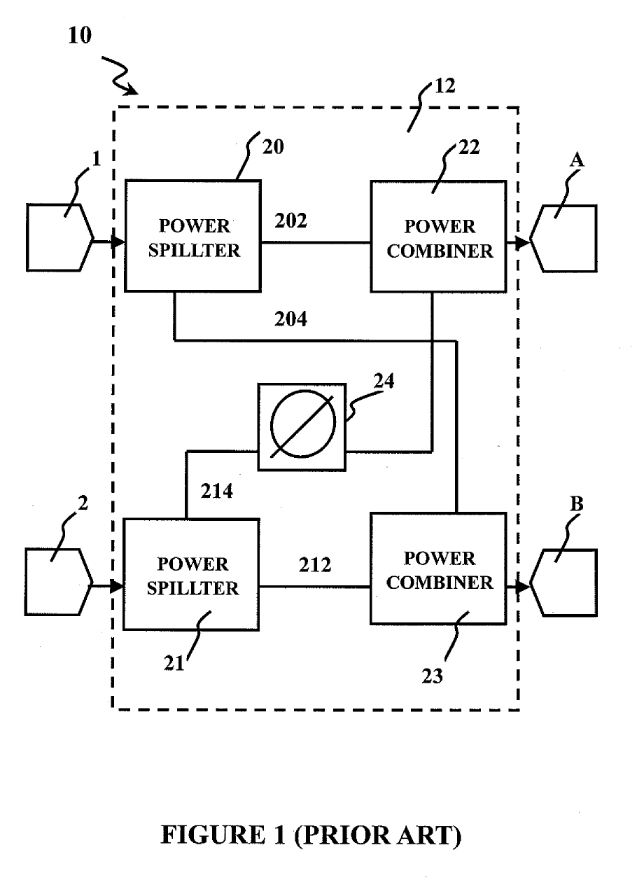

FIG. 2 is a schematic view of a conventional power splitter;

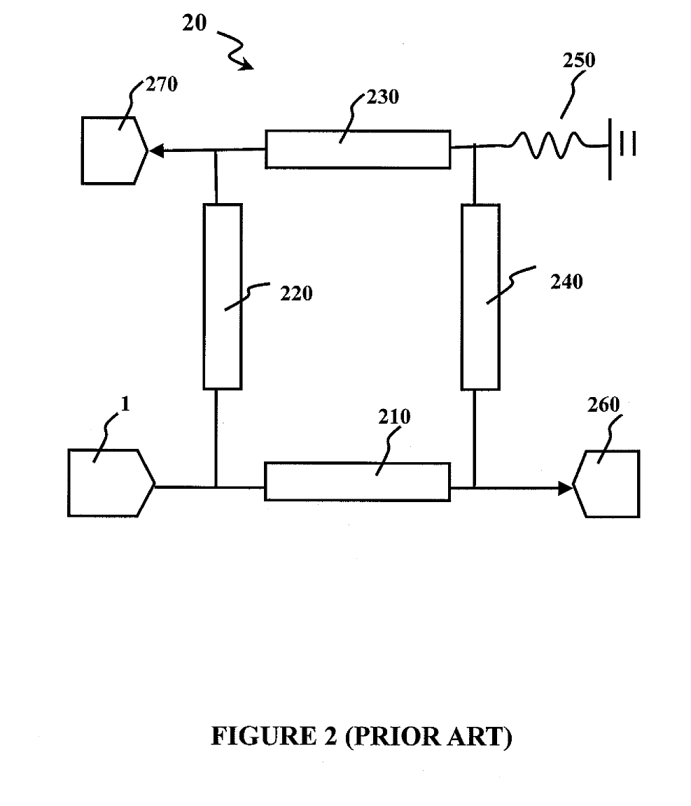

FIG. 3 is a simulated result of a conventional channel emulator;

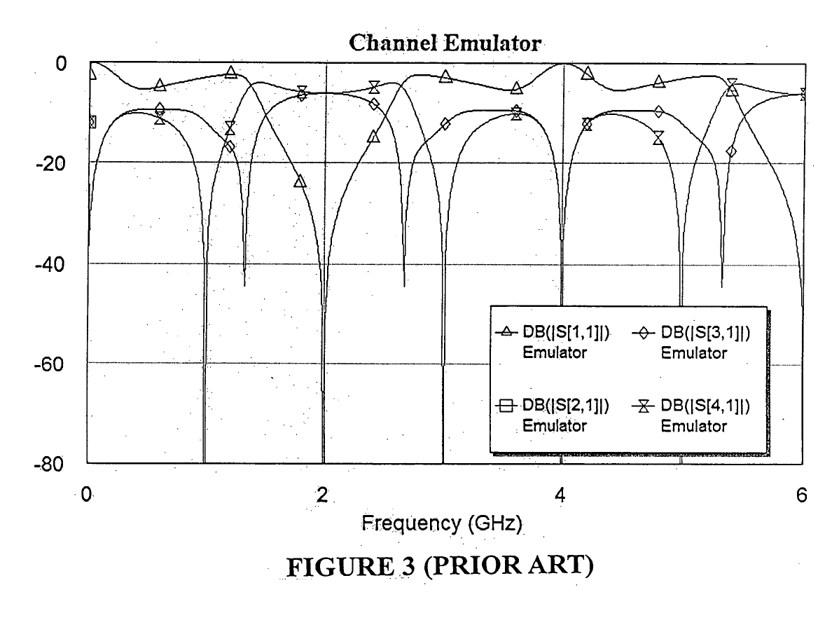

FIG. 4 is a schematic view of a first embodiment of the broadband emulator;

FIG. 5 is a schematic view of a first embodiment of the broadband splitter;

FIG. 6 is a simulated result of the present invention of the broadband emulator.

### DETAILED DESCRIPTION

Broadband Emulator

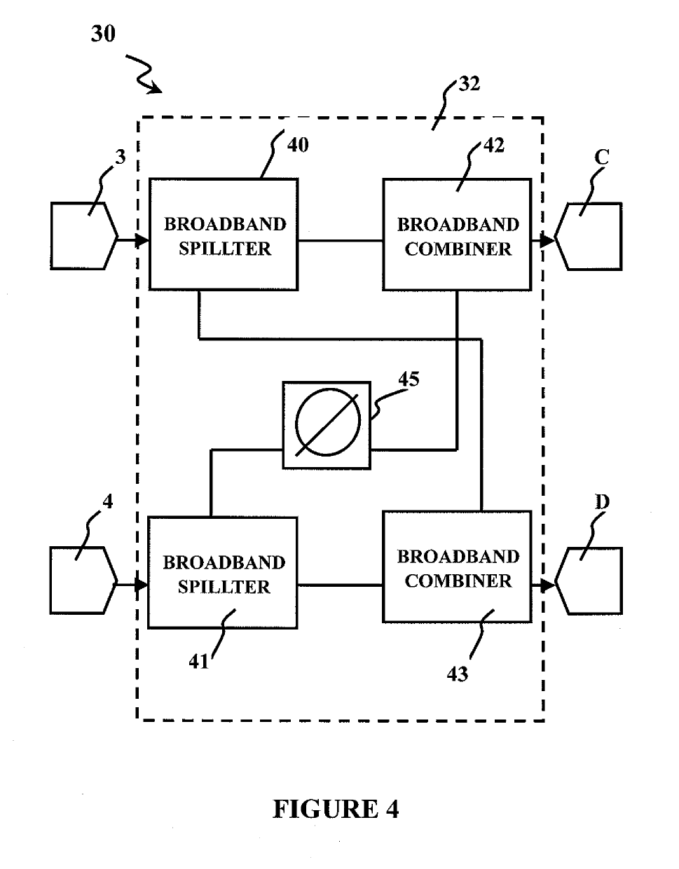

FIG. 4 shown an embodiment of present invention, a broadband emulator 30 is illustrated in a simplified block schematic diagram. The RF (Radio Frequency) input signals to the broadband emulator 30 are provided to a first input channel 1 and to a second input channel 2.

The broadband emulator 30 comprises a mixing matrix 32. The mixing matrix 32 includes two broadband splitters 40, 41 generating a plurality of signals, two broadband combiners 43, 44 combining both the phase shifted signals and non-phase shifted signals, a phase shifter 45 providing for additional adjustment of transmit correction, wherein the phase shifter 45 can be a 180 degree phase shifter.

The output channel 3 signal is the sum of a 180 degree phase shifted signal from the broadband splitter 41 and a non-phase shifted signal from the broadband splitter 40. The output channel 4 signal is the sum of non-phase shifted signals from the broadband splitter 41 and the broadband splitter 42.

Broadband Splitter

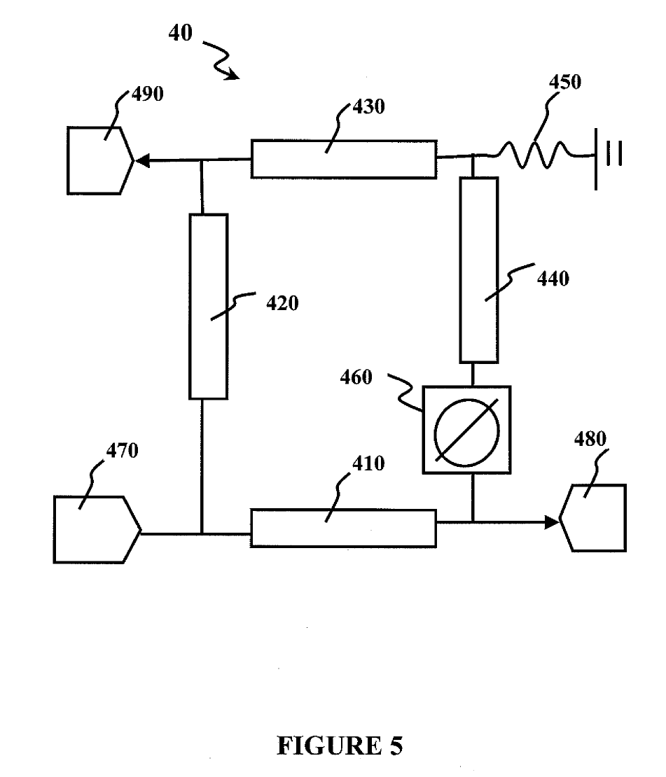

FIG. 5 shown an embodiment of the present invention, a broadband splitter 40 is illustrated in a simplified schematic diagram. The broadband splitter 40 receives one input signal from the first channel 1 and generates two output signal paths.

The broadband splitter 40 includes four transmission lines 410, 420, 430, 440, a resistor 450 being provided as a termination, a phase shifter 460. The transmission line 410 connects with the first channel 1 and an output port 480. Similarly, transmission line 420 connects with the first channel 1 and an output port 490. The transmission line 430 connects with the output port 490 and the termination resistor 450. The transmission line 440 connects the output port 480 and the termination resistor 450. In addition, the phase shift 460 can be positioned in the transmission path between the transmission line 440 and the output port 480 or between the transmission line 440 and the termination resistor 450.

Each transmission line 410, 420, 430, 440 is characterized by a characteristic impedance of 70.7 Ohm and function as quarter-wave transformers for providing a center frequency electrical transmission phase of 90 degree.

The phase shifter 460 is a 180 degree phase shifter. The impedance of the first channel 1, the output ports 480, 490, and the resistor 450 are typically 50 Ohms. Additionally, the output ports of the broadband splitter (or the input ports if it is being used as the broadband combiner) are isolated from each other. As described above, the broadband splitter 41, the broadband combiner 43, 44 can be known.

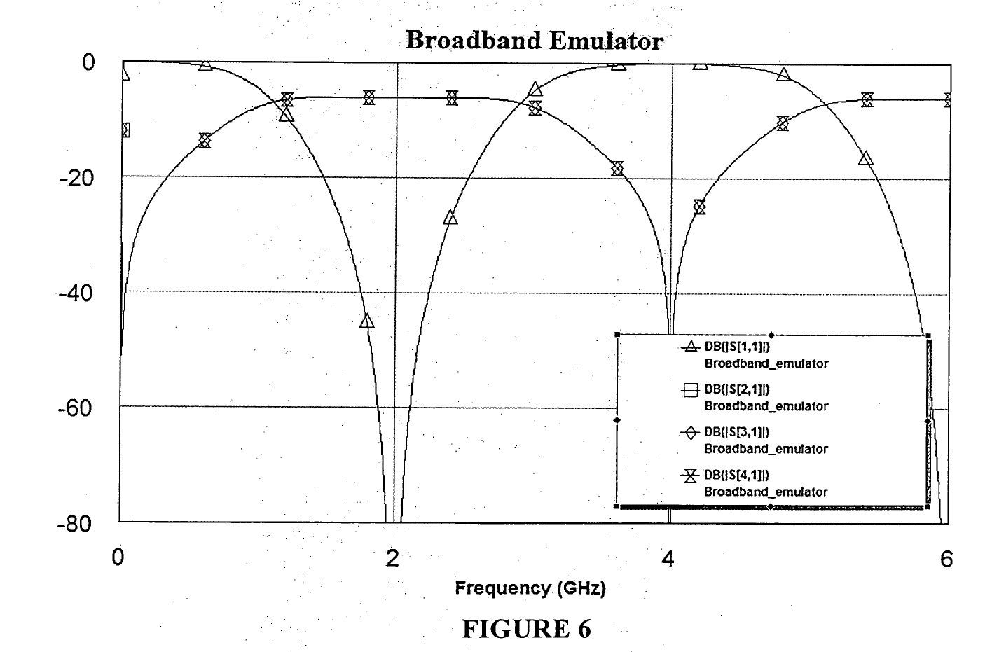

FIG. 6 is the simulated result of the broadband emulator which shows that with an ideal 180 phase shifter, the fractional bandwidth can reach around 79%. The broadband splitters having two equal amplitude in-phase signals are isolated from each other, and the improved bandwidth performance of the broadband emulator compared with the conventional channel emulator, it indicates that the present invention is an ideal candidate for RF emulation system

It is to be understood that the embodiment described is provided as an example. The number of channel emulators is not limited to the number described and shown and the input and output matrix configuration can be varied.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

Having described the invention, the following is claimed:

1. A MIMO broadband emulator comprising a mixing matrix, comprising;
a plurality of broadband splitters, each broadband splitter receiving one RF input signal and generating a plurality of signal paths;
a plurality of broadband combiners coupled to related said plurality of broadband splitters, each said plurality of broadband combiner receiving more than one signal paths, at least one of said plurality of broadband combiner receiving a phase-shifted signal path, and each said plurality of broadband combiner generating one output signal;
at least one of phase shifters for phase shifting coupled between said plurality of broadband combiners and said plurality of broadband splitters; and
wherein each said plurality of broadband splitters comprises transmission lines function as quarter-wave transformers providing a center frequency electrical transmission phase of 90 degree and one 180 degree phase shifter positioned in the one of the transmission line path for phase shifting.

2. The MIMO broadband emulator of claim 1, wherein said four transmission line are characterized by a characteristic impedance of 70.7 Ohm.

3. The MIMO broadband emulator of claim 1, wherein said broadband splitter further comprising a resistor as a termination.

4. The MIMO broadband emulator of claim 3, wherein said resistor is 50 Ohm.

5. The MIMO broadband emulator of claim 3, wherein said 180 degree phase shift is positioned in the transmission path between one of said transmission lines and said resistor.

6. A broadband splitter comprising;
transmission lines function as quarter-wave transformers providing a center frequency electrical transmission phase of 90 degree;
one 180 degree phase shifter positioned in the one of said transmission line path for phase shifting; and
a resistor coupled to at least one of said transmission lines to function as a termination.

7. The broadband splitter of claim 6, wherein said four transmission line are characterized by a characteristic impedance of 70.7 Ohm.

8. The broadband splitter of claim 6, wherein the impedance of said resistor is 50 Ohm.

9. The broadband splitter of claim 6, wherein said 180 degree phase shift is positioned in the transmission path between one of said transmission lines and said resistor.

10. The broadband splitter of claim 6, wherein said 180 degree phase shift is positioned in the transmission path between one of said transmission lines and an output port.
